(19) United States
(12) Patent Application Publication
(10) Pub. No.: US 2006/0159437 A1
(43) Pub. Date: Jul. 20, 2006

(54) Heated metering device for the reformer of a fuel cell arrangement

(76) Inventor: Frank Miller, IIsfeld (DE)

Correspondence Address: KENYON & KENYON LLP, ONE BROADWAY, NEW YORK, NY, 10004, US

(21) Appl. No.: 10/537,032

(22) PCT Filed: Sep. 16, 2003
(86) PCT No.: PCT/DE03/03072

§ 371 Date: Nov. 14, 2005

(30) Foreign Application Priority Data
Dec. 3, 2002 (DE) 102 56 453.1

(51) Int. Cl. H05B 3/78

(52) U.S. Cl. 392/485

(57) ABSTRACT

A dosing device for liquid fuels, in particular for input into a chemical reformer in order to recover hydrogen or into a post-combustion device in order to generate heat, comprises at least one metering device for metering fuel into a metering conduit and a nozzle body, adjoining the metering conduit, having spray discharge openings which open into a metering chamber, the dosing device comprising at least one heating element made up of a wire braid networked in mesh fashion and/or a tubular hollow element, with which heat can be delivered to the fuel.

### FIELD OF THE INVENTION

The present invention relates to a dosing device.

### BACKGROUND INFORMATION

In fuel-cell-assisted transport systems, so-called chemical reformers are used to recover the necessary hydrogen from hydrocarbon-containing fuels such as, for example, gasoline, ethanol, or methanol. Catalytic burners and/or secondary combustion devices are used for heat generation, in particular in cold-start phases.

All the substances required by the reformer for execution of the reaction, for example air, water, and fuel, are conveyed to the reaction region ideally in a gaseous state. Because water and the fuels, for example methanol or gasoline, are preferably present in liquid form on board the transport system, they must first be heated shortly before they arrive at the reaction region of the reformer in order to evaporate them. This necessitates a pre-evaporator that is capable of making available the corresponding quantities of gaseous fuel and water vapor, the waste heat of the reformer usually being used for evaporation. Similar considerations apply to the catalytic burner and secondary combustion device.

Since the hydrogen is usually consumed immediately, chemical reformers must be capable of instantaneously adapting the production of hydrogen to demand, e.g., in the context of load changes or startup phases. Additional measures must be taken in the cold-start phase in particular, since the reformer is not providing any waste heat. Conventional evaporators are not capable of instantaneously generating the corresponding quantities of gaseous reactants.

In operating states in which the reformer or the catalytic burner and secondary combustion device are working at less than operating temperature, it is therefore useful to convey heat to the fuel already by way of the dosing device. As a result, the delivered fuel or fuel/gas mixture is more reactive, and can evaporate faster and more easily and mix more completely.

Apparatuses for dosing fuels into reformers are described in, for example, U.S. Pat. No. 3,971,847. Here the fuel is fed in, by metering devices relatively remote from the reformer, through long delivery conduits and a single nozzle into a temperature-controlled material stream. The fuel first strikes impact panels that are disposed after the outlet opening of the nozzle and are intended to cause turbulence in and distribution of the fuel, and then travels into the reaction region of the reformer through a relatively long evaporation section that is necessary for the evaporation process. The long delivery conduit allows the metering device to be insulated from thermal influences of the reformer.

A particular disadvantage of the apparatuses described in the aforementioned document is the fact that below the operating temperature of the reformer, for example in a cold-start phase, atomization and evaporation of the fuel occur only insufficiently. Because of the relatively small reaction surface between fuel and oxidizer resulting in this context, combustion or chemical reaction occurs only slowly, and usually also incompletely. The result is a distinct decrease in efficiency and a disadvantageous increase in pollutant emissions. Incomplete combustion or an incomplete chemical reaction usually results in the formation of aggressive chemical compounds that can damage the chemical reformer or secondary combustion device and cause deposits that can degrade functionality. Operating states in which the operating temperature is not reached are lengthened by the insufficient atomization and by the associated insufficient mixing and chemical reaction of the fuel and oxidizer.

### SUMMARY

An example dosing device according to the present invention may have, in contrast, the advantage that atomization and distribution of the fuel or fuel/gas mixture is substantially improved as a result of the preheating using a heating element associated with the dosing device. The result is that, for example, the cold-start phase can be substantially shortened, and the efficiency of the catalytic burner or the secondary combustion device or chemical reformer can be greatly increased already during the cold-start phase. Pollutant emissions are substantially reduced in this context. Complex and therefore expensive apparatuses for mixture preparation and spray preparation can be omitted. With similar or better atomization, it is possible in particular to dispense with an energy-intensive air assistance system that is complex to manufacture and difficult to regulate, so that the dosing device requires less energy and is easier to manufacture and regulate. In addition, for example, an air compressor can be dispensed with.

The heating element is made up of a mesh-like wire braid, preferably made of metal, or a hollow element made of electrically heatable material. As a result, the Joule heat that is generated can be transferred particularly uniformly, easily and in well-distributed fashion to the fuel or to the respective element of the dosing device that in turn transfers heat to the fuel or the fuel/gas mixture. A heating element of this kind can moreover be adapted particularly well to particular geometric requirements, is economical to manufacture and strong, and requires little energy input and only a small amount of space. In particular, the heating element can be used before or in commercially available swirl nozzles, before or in any desired atomization capability for fuel-cell technology, for example reformers, secondary burners, startup burners, etc., or in heating technology.

In a first refinement of the dosing device according to the present invention, the metering conduit and the metering device are joined in hydraulically sealed and detachable fashion by way of an adapter. This improves ease of installation.

In a further refinement, the adapter connecting the metering conduit and the metering device has an air inlet, the air inlet being connected, in the adapter, to the metering conduit. The result is that mixture preparation can already be initiated in the delivery conduit, the fuel metered into the delivery conduit being mixed with air. The result is an overall improvement in atomization of the fuel, and in formation of the mixture of fuel and air.

Advantageously, the heating element is heated or operated electrically. Among the consequences of this is that the heating element can be adapted particularly easily to a wide variety of geometric shapes, and activation and energy supply can also be performed particularly simply and therefore economically.

It is additionally advantageous if the heating element can deliver heat at least to a part of the metering conduit, of the adapter, of the nozzle body, and/or of the metering device. The result is that heat can be delivered to the fuel shortly before mixture formation with air or with another gas, or shortly before dosing into the metering chamber. Because of the relatively short distances from the spray discharge opening, only a small amount of the heat generated by the heating element is lost. Dosing of the heat delivered to the fuel or the fuel/gas mixture can thus be effected in well-controlled and very accurate fashion, and with minimal energy expenditure. The different heat delivery locations also allow physical circumstances to be addressed in flexible fashion.

Immobilization of the heating element using an attachment element made of plastic, dip resin, or ceramic allows the respective thermal and mechanical requirements to be met in advantageously simple fashion.

It is additionally advantageous if the heating element or attachment element is at least partially surrounded by an insulating layer, made in particular of ceramic or a plastic. This allows the energy consumption of the heating element to be further lowered, and the controllability of heat delivery by the heating element to be further improved. In particular, the time constant of the heating operation is shortened.

It is furthermore advantageous if a controller regulates the heating element in terms of its heat output, in particular on the basis of the temperature existing in the metering chamber. Regulation can also be accomplished on the basis of other parameters of the reformer or the post-combustion device. The regulation can also be a simple time-based control of the heat output. This refinement according to the present invention prevents overheating of the fuel or fuel/gas mixture and the dosing device, and minimizes the energy consumption of the heating element.

A fuel injection valve, such as the one used, e.g., for reciprocating-piston machines with internal combustion, is advantageously utilized as the metering device. The use of such valves has several advantages. For example, they permit particularly accurate open- or closed-loop control of fuel metering, in which context the metering can be controlled by way of several parameters such as pulse duty factor, clock frequency, and optionally stroke length. The dependency on pump pressure is much less pronounced than in the case of metering devices that control the volumetric flow of the fuel by way of the conduit cross section, and the dosing range is much larger.

In addition, fuel injection valves are economical, reliable components that have proven successful in many ways, are known in terms of their behavior, and are chemically stable with respect to the fuels used; this is true in particular of so-called low-pressure fuel injection valves that can be used with advantage here because of the thermal decoupling resulting from the metering conduit.

The delivery conduit advantageously has a number of reduced-wall-thickness points that decrease the thermal conductivity of the metering conduit and can also serve as heat sinks.

It is additionally advantageous to dispose the heating element after the spray discharge opening. It is thereby possible, for example, to heat and thus atomize the fuel/gas mixtures of several dosing devices in simple fashion.

The dosing device can be designed in a particularly simple fashion that is easily adaptable to particular requirements if the heating element is disposed in the nozzle body (7) and/or in the metering conduit and/or in the adapter (6) and/or in or on the metering device (2).

The multi-part construction of the dosing device makes possible economical manufacture and the use of standardized components.

### BRIEF DESCRIPTION OF THE DRAWINGS

Exemplary embodiments of the invention are depicted in simplified fashion in the figures and explained in more detail below.

FIG. 1 schematically depicts a first example embodiment of a dosing device according to the present invention.

FIG. 2 schematically depicts a second example embodiment of a dosing device according to the present invention.

FIG. 3 schematically depicts a third example embodiment of a dosing device according to the present invention.

FIG. 4 schematically depicts a fourth example embodiment of a dosing device according to the present invention.

FIG. 5 schematically depicts a fifth example embodiment of a dosing device according to the present invention.

### DETAILED DESCRIPTION OF EXAMPLE EMBODIMENTS

An exemplary embodiment of the present invention is described below by way of example.

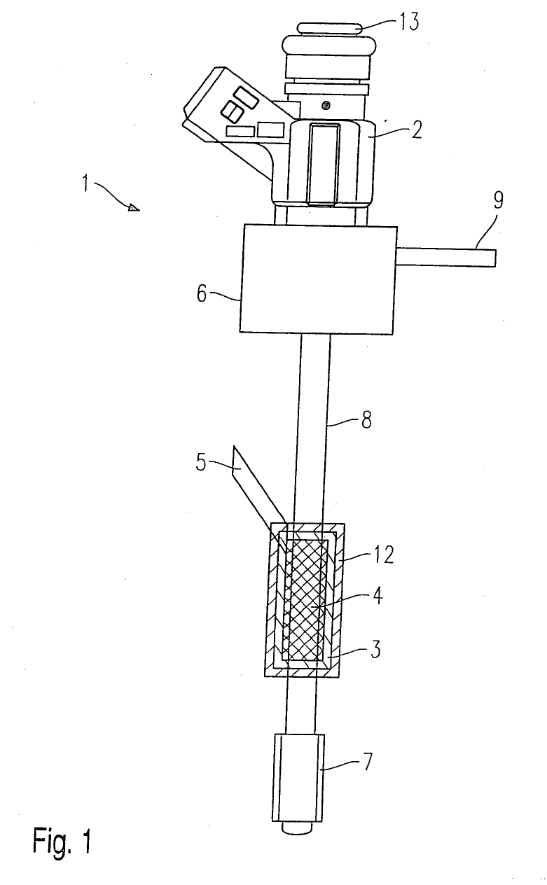

An example embodiment of a dosing device 1 according to the present invention depicted in FIG. 1 is embodied in the form of a dosing device 1 for the use of low-pressure fuel injection valves. Dosing device 1 is suitable in particular for the input and atomization of fuel or a fuel/gas mixture into a metering chamber (not depicted) of a chemical reformer (not depicted in further detail) in order to recover hydrogen, or of a post-combustion device or catalytic burner (not depicted in further detail) in order to generate heat, in which context the metering chamber can be configured as a hollow cylinder having a coated inner surface.

Dosing device 1 encompasses a metering device 2 which in this example embodiment is embodied as a low-pressure fuel injection valve, an electrical connector 5, an adapter 6 for receiving metering device 2 and a tubular metering conduit 8, e.g., 10 to 100 cm long, an air inlet 9, and a nozzle body 7. Metering device 2 is tubular. Metering of fuel into metering conduit 8 is accomplished on the underside of metering device 2, adapter 6 connecting metering device 2 and metering conduit 8 to one another in an externally hydraulically sealed manner. Tubular air inlet 9 opens into adapter 6 and is thus connected to delivery conduit 8.

The hollow-cylindrical end of nozzle body 7 facing toward metering conduit 8 encompasses the corresponding end of metering conduit 8 and is connected there in hydraulically sealed fashion to metering conduit 8 by way of a join that can be a welded or threaded connection, in particular a join produced by laser welding. Metering conduit 8 itself is made, for example, of a standardized metal tube made of stainless steel.

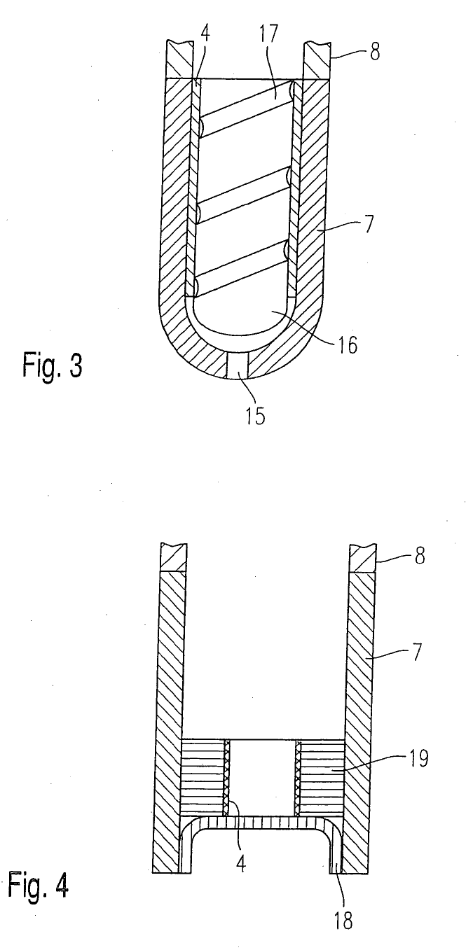

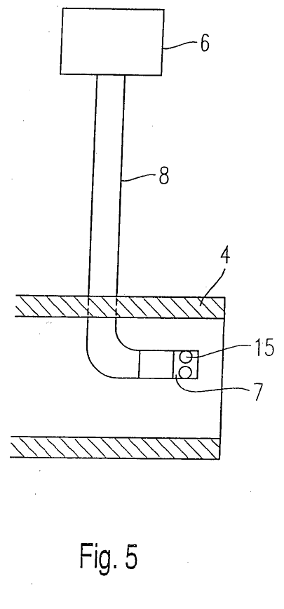

Nozzle body 7 has, in its spherical portion at the spray-discharge end that is shaped like a spherical segment or semi-sphere, at least one spray discharge opening 15 depicted in FIGS. 3 and 5.

Over a portion of its axial extent, metering conduit 8 has a grid-like heating element 4, made preferably of metal, in the form of a wire braid. Heating element 4 surrounds metering conduit 8 around the outside diameter of metering conduit 8; heating element 4 rests closely against metering conduit 8 and is immobilized on metering conduit 8 by an attachment element 3 in the form of a dip resin layer made of a heat-resistant dip resin, and is thermally insulated toward the outside. Disposed around attachment element 3 is an additional insulating layer 12 that additionally thermally insulates heating element 4. Insulating layer 12 is made, for example, of a heat-resistant plastic or a ceramic material. The insulating function can also be assumed entirely by attachment element 3.

An electrical connector 5 is connected on the less thermally stressed side of heating element 4 facing toward adapter 6, and engages through attachment element 3 and insulating layer 12. Electrical connector 5 is preferably disposed in a region of metering conduit 8 that reaches a temperature of no more than 80° C. during operation. When dosing device 1 according to the present invention is used in a chemical reformer (not depicted) for fuel-cell vehicles, this region is located in the so-called peripheral box, which is not depicted.

A controller (not depicted) regulates the current flowing through heating element 4 and thus the heat output of heating element 4. The heat output is regulated, for example, as a function of the temperature in the metering chamber (not depicted) or by way of a characteristic curve stored in the controller that senses further operating parameters, for example the time elapsed since the startup of dosing device 1 or, for example, of the associated secondary combustion device (not depicted).

Fuel, for example gasoline, ethanol, or methanol, is delivered under pressure from a fuel pump and fuel line (not depicted) to metering device 2 through a fuel connector 13 located on the upper side of metering device 2. The fuel flows downward when dosing device 1 is in operation, and is metered into delivery conduit 8 through the sealing seat (not depicted) located in the lower end of metering device 2 in a conventional fashion, by opening and closing of the sealing seat.

Air or other gases, for example combustible residual gases from a reforming or fuel-cell process, can be delivered, for mixture preparation, through air inlet 9 that opens laterally via adapter 6 into delivery conduit 8 near metering device 2. As it continues, the fuel or fuel/gas mixture flows through delivery conduit 8 to nozzle body 7 and is there metered through spray discharge openings 15 (depicted in FIGS. 3 and 5) into the metering chamber (not depicted).

The fuel or fuel/gas mixture is heated, especially at the beginning of a cold-start phase, in delivery conduit 8 by heating element 4. Atomization of the fuel is thereby distinctly improved. The fuel is, in particular, heated until the fuel is completely evaporated. The fuel or fuel/gas mixture is thus, for example in a cold-start phase, already completely in the vapor phase upon entry into the metering chamber (not depicted). In a motor vehicle in particular, heating element 4 can, for example, already be supplied with electrical power as the motor vehicle is opened, occupied, or started. The cold-start phase is thereby further shortened.

The heating element is operated until the operating temperature of the secondary combustion device, chemical reformer, or catalytic burner (not depicted) is reached.

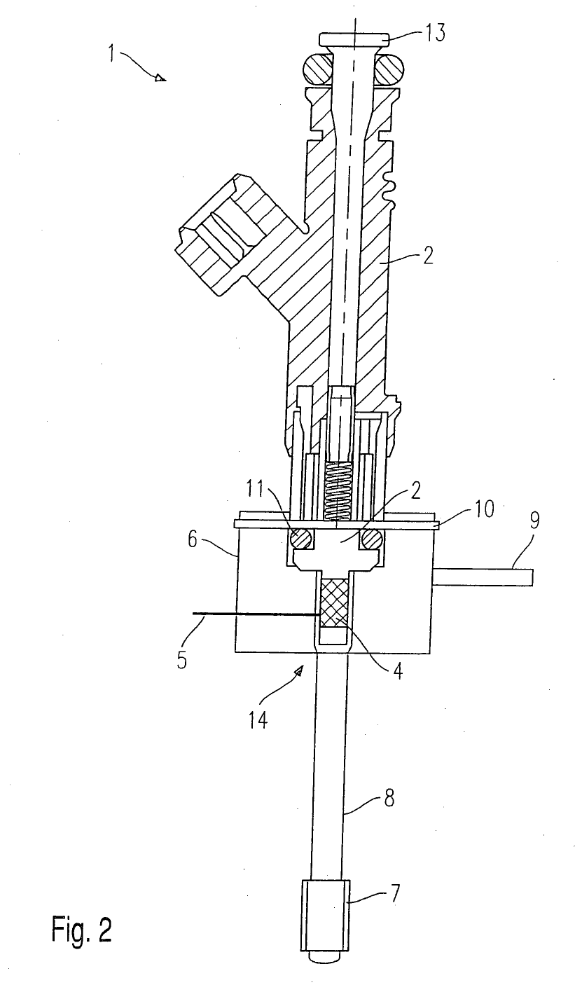

FIG. 2 shows a second example embodiment of the dosing device 1 according to the present invention, similar to the first exemplified embodiment.

In the exemplary embodiment of FIG. 2, metering device 2 engages with its underside, in which a sealing seat (not depicted) of metering device 2 is disposed, into a through opening 14 of adapter 6. Metering device 2, embodied as a fuel injection valve, is connected detachably to adapter 6 by way of an immobilization element 10, and a sealing ring 11 that extends around the tubular underside of metering device 2 seals opening 14 between metering device 2 and adapter 6 in hydraulically sealed fashion. Metering conduit 8 is on the one hand connected in hydraulically sealed fashion to the side of opening 14 facing away from metering device 2, and on the other hand closed off by nozzle body 7. Air inlet 9 opens into adapter 6 and is connected to metering conduit 8 via adapter 6.

Heating element 4 sits on the underside of metering device 2 which extends inside adapter 6. Electrical connector 5 engages through adapter 6 and makes contact to heating element 4 embodied as a wire-mesh net.

FIG. 3 is a schematic depiction of a third example embodiment of a dosing device 1 according to the present invention in the region of nozzle body 7. In this example embodiment, nozzle body 7 is configured in the form of a hollow cylinder, one end being open and closed off in hermetically sealed fashion by metering conduit 8. The other end is terminated spherically and has a centrally arranged spray discharge opening 15.

Disposed inside nozzle body 7 is a swirl insert 16 that is adapted, with a smaller diameter, to the inner contours of nozzle body 7. A swirl channel 7 extends helically in the surface of nozzle body 7. The tubular heating element 4, made of a wire-mesh net, is disposed as an insert between swirl insert 16 and the inner circumference of nozzle body 7.

FIG. 4 is a schematic depiction of a fourth example embodiment of a dosing device 1 according to the present invention in the region of nozzle body 7; in contrast to the third example embodiment of FIG. 3, nozzle 7 is terminated at its end facing away from metering conduit 8 not spherically, but rather with a perforated spray disk 18 that has several spray discharge openings 15 (not depicted in further detail). Disposed on the side of perforated spray disk 18 facing toward metering conduit 8 is an annular element 19 that decreases the inside width of nozzle body 7 toward perforated spray disk 18. Heating element 4 is disposed as an insert directly on the inner circumference of annular element 19, heating element 4 here likewise being made up of a wire-mesh net and being embodied in tubular fashion.

FIG. 5 is a schematic depiction of a fifth example embodiment of a dosing device 1 according to the present invention. Here heating element 4 is arranged after spray discharge openings 15 by the fact that metering conduit 8 engages laterally through heating element 4, which is tubular in this example embodiment. Spray discharge openings 15 open into the metering chamber (not depicted) with heating element 4 interposed.

1-13. (canceled)

14. A dosing device for a liquid fuel, for input into a chemical reformer in order to recover hydrogen or into a post-combustion device in order to generate heat, comprising:
at least one metering device to meter fuel into a metering conduit;
a nozzle body adjoining the metering conduit, the nozzle body having at least one spray discharge opening which opens into a metering chamber; and
at least one heating element with which heat can be delivered to the fuel, including at least one of a wire braid networked in mesh fashion, and a tubular hollow element.

15. The dosing device as recited in claim 14, further comprising:
an adapter, the metering conduit and the metering device being joined in hydraulically sealed and detachable fashion by way of the adapter.

16. The dosing device as recited in claim 15, wherein the adapter has an air inlet that is connected, in the adapter, to the metering conduit.

17. The dosing device as recited in claim 14, wherein the heating element is operated or heated electrically.

18. The dosing device as recited in claim 14, wherein the heating element delivers heat at least to a part of at least one of the metering conduit, the adapter, the metering device, and the nozzle body.

19. The dosing device as recited in claim 14, wherein the heating element is immobilized using an attachment element made of one of plastic, dip resin, or ceramic.

20. The dosing device as recited in claim 19, wherein at least one of the heating element and the attachment element is at least partially surrounded by an insulating layer made of one of a temperature-resistant plastic or ceramic.

21. The dosing device as recited in claim 14, wherein the heating element is regulated in terms of heat output by a controller.

22. The dosing device as recited in claim 21, wherein the heating element is controlled based on a temperature in the metering chamber.

23. The dosing device as recited in claim 21, wherein the heating element is controlled based on operating parameters.

24. The dosing device as recited in claim 14, wherein the metering device is a fuel injection valve.

25. The dosing device as recited in claim 24, wherein the fuel injection valve is a low-pressure fuel injection valve that operates at fuel pressures of up to 10 bar.

26. The dosing device as recited in claim 14, wherein the metering conduit has in an axial extent at least one reduced-wall-thickness region.

27. The dosing device as recited in claim 14, wherein the heating element is disposed after the spray discharge opening.

28. The dosing device as recited in claim 14, wherein the heating element is disposed at least one of: i) in the nozzle body, ii) in the metering conduit, iii) in the adapter, and iv) in or on the metering device.
